(19) United States
(12) Patent Application Publication
(10) Pub. No.: US 2003/0107195 A1
(43) Pub. Date: Jun. 12, 2003

(54) Structural foam plastic having electrostatic dissipative properties, mobile cart embodying same, and method of using same

(75) Inventors: Adam Zambanini, Winchester, VA (US); Bernard H. Olmsted, Winchester, VA (US)

Correspondence Address: FOLEY AND LARDNER, SUITE 500, 3000 K STREET NW, WASHINGTON, DC, 20007, US

(73) Assignee: RUBBERMAID COMMERCIAL PRODUCTS LLC

(21) Appl. No.: 10/004,412

(22) Filed: Dec. 6, 2001

(51) Int. Cl. B62B 3/00

(52) U.S. Cl. 280/47.34; 280/47.35

(57) ABSTRACT

An injection molded mobile maintenance cart, made of electrostatic dissipative material, exhibits permanent, consistent, and controlled resistivity in the range of 10⁶ to 10⁹ ohms/square. The cart is made out of structural foam plastic which includes electrostatic dissipative components. Inadvertent destruction of electronic components by a discharge of static electricity passing through a cart which carries the components is inhibited by ensuring that the cart is made from an electrostatic dissipative material.

### BACKGROUND OF THE INVENTION

1. Field of the Invention

The present invention relates to electrostatic dissipation devices. More specifically, the invention relates to mobile carts which are made out of electrostatic dissipative materials and which carry equipment sensitive to static electricity, such as microchips, circuit boards, and components thereof.

2. Description of the Related Art

Production of integrated circuits and printed circuit boards has increased dramatically in the last decade. Demand for those electronic components has increased as demand has increased for their use in products such as computers, appliances, cars, medical equipment, and telecommunications devices.

In the manufacture of the electronic components, it is essential to reduce, or hopefully eliminate, static electricity. Static electricity can cause electrical damage that renders unusable the often expensive electronic components. In addition, static electricity in the manufacturing environment can create significant problems, such as: (a) igniting flammable materials and chemicals used in the manufacturing process; (b) attracting contaminants into clean environments; and (c) causing products to stick together. These problems also can be very expensive with regard to, for example, replacement of damaged equipment or material, lost production time, and costs associated with preventing further occurrences of the problems.

Mobile carts, which are used to transport the electronic components during the manufacturing process, can cause static electricity to discharge and damage the electronic components. For this reason, conventional carts, which are often made of either plastic or metal, have proven troublesome in the manufacture of electronic components.

Plastic carts are typically highly resistive, displaying a resistivity above 1011 ohm/square (the unit “ohm/square” is a conventional unit by which various megaohm meters are calibrated to yield essentially the same output reading). Due to the high resistivity of the plastic cart, it can store a static electricity charge. When the cart is grounded, e.g., when a person touches the cart, the static electricity charge will discharge and may damage electronic components in contact with the cart.

In contrast, metal carts typically are highly conductive. For example, metal carts often have a resistivity below 10⁵ ohm/square. If the metal cart is not connected to ground, the cart can store a static electricity charge, resulting in a problem similar to that experienced with plastic carts. To combat this problem, metal carts have been provided with grounding devices to prevent a static charge from accumulating in the cart, such as a chain dragged behind the cart or conductive wheels. Drag chains are cumbersome and may become disconnected or lose contact with the ground, thus failing to serve their intended purpose. Even if the cart remains connected to ground, a static charge stored in a person or object will be readily discharged through the cart when the person or object contacts the cart. This discharge can damage electronic components in contact with the cart. In addition, metal carts are less desirable to users because they are more prone to impact damage and corrosion than plastic carts.

In an effort to reduce the problems associated with static electricity, a mobile cart has been proposed having a conductive framework and a bin formed of an outer conductive layer intended to provide a Faraday shield and an inner, static dissipative layer intended to slowly bleed static electricity. This cart is considered to be undesirable, however, because if an electrical component comes in contact with the conductive layer or framework, it will be subject to destruction if a person or object storing a static charges contacts the conductive layer or framework, as the charge will be transferred from the person or object to the ground via the conductive layer (or framework) and the electrical component in contact therewith. Similarly, if the cart loses contact with the ground and subsequently has a charged stored therein, any electrical component touching the conductive layer or framework will be subject to damage when the cart is re-grounded due to the dissipation of the charge stored therein.

For these and other reasons, a new cart is needed for transporting electronic components.

### SUMMARY OF THE INVENTION

A first aspect of the invention involves an electrostatic dissipative cart which includes a grounded cart body which has a resistivity in the range of 10⁶ ohms/square and 10⁹ ohms/square; the resistivity being measured between ground and substantially all exterior points on the cart body. In addition, the cart also includes at least one rolling member which support the cart body.

In the first aspect of the invention, the cart body may include at least one electrostatic dissipative material. Moreover, the cart body may formed substantially entirely of electrostatic dissipative material. If the cart body includes an electrostatic dissipative material, the material may be structural foam plastic. Further, the structural foam plastic may include polypropylene and/or nylon. It is preferable that the cart body include a carrier for carrying electronic components and at least one support for supporting the carrier. In addition, the cart body preferably includes a base connected to the at least one support.

With respect to the at least one rolling member of the first aspect of the invention, the at least one rolling member may be grounded and have a resistivity in the range of 10⁶ ohms/square and 10⁹ ohms/square as measured between substantially all exterior points on the at least one rolling member and ground. Similar to the at least one rolling member, the resistivity of the cart body may be in the range of 10⁶ ohms/square and 10⁹ ohms/square as measured between ground and all exterior points on the cart body.

A second aspect of the invention address an electrostatic dissipative cart body including a carrier configured to carry at least one electronic component and at least one support supporting the carrier; both the carrier and the at least one support comprise an electrostatic dissipative material. According to the second aspect of the invention, the cart body may be grounded and have a resistivity in the range of 10⁶ ohms/square and 10⁹ ohms/square as measured between ground and all exterior points on the carrier or on the at least one support. In this second aspect of the invention, the electrostatic dissipative material may be structural foam plastic. Moreover, the structural foam plastic may include polypropylene and/or nylon.

A third aspect of the invention involves an electrostatic dissipative cart body which includes a carrier configured to carry at least one electronic component and at least one support supporting the carrier. At any selected point on the cart body above a predetermined height, the cart body has a resistivity in the range of 10⁶ ohms/square and 10⁹ ohms/square as measured between ground and the selected point. According to the third aspect of the invention, the carrier and the at least one support may include an electrostatic dissipative material. In addition, above the predetermined height, the at least one support and the carrier may include structural foam plastic.

A fourth aspect of the invention involves a rolling member which includes a rolling body having a substantially circular cross section and containing at least one electrostatic dissipative material. The rolling member also includes a support structure which is connected to the rolling body and is adapted to be connected to a platform. The rolling body may be grounded and may have a resistivity in the range of 10⁶ ohms/square and 10⁹ ohms/square as measured between ground and any point on the rolling body. In addition, the support structure may include a yolk and an axle.

A fifth aspect of the invention addresses a method for transporting electronic components. This method includes: (a) providing a cart body having at least one support upright, at least one carrier supported by the at least one support upright, and at least two rolling members attached to an underside of the cart body; (b) placing at least one electronic component on the at least one carrier; and (c) moving the cart by means of the at least two rolling members. In addition, in performing this method, the at least one support upright and the at least one carrier include at least one electrostatic dissipative material.

In the method addressed by the seventh aspect of the invention, the at least one carrier may be a shelf or a bin. In addition, the electrostatic dissipative material may have a resistance between 10⁶ ohms/square and 10⁹ ohms/square and may be structural foam plastic. If the electrostatic dissipative material is structural foam plastic, the plastic may include polypropylene and/or nylon.

Another method for transporting electronic components is addressed by an eighth aspect of the invention. This method includes: (a) providing a cart body having at least one support upright, at least one platform supported by the at least one support upright, and at least two rolling members attached to an underside of the cart body; (b) placing at least one electronic component on the at least one platform; and (c) moving the cart by means of the at least two rolling members. In performing the method according to the eighth aspect of the invention, the cart body is grounded and has a resistivity in the range of 10⁶ ohms/square and 10⁹ ohms/square as measured between ground and substantially all exterior points on the cart body. In addition, each of the rolling members may have a rolling body and a support structure; the resistivity of the rolling body, as measured between a position on the rolling body and the ground, may be between 10⁶ ohms/square and 10⁹ ohms/square.

The invention also provides for a method of forming a structure. This method includes providing an electrostatic dissipative material and forming the material into structural foam plastic.

A product provides another aspect of the invention. The product includes structural foam plastic which, in turn, includes electrostatic dissipative material. When the structural foam plastic of the product is electrically connected to ground, the structural foam plastic exhibits a resistivity, as measured between a position on the structural foam plastic and the ground, between 10⁶ ohms/square and 10⁹ ohms/square.

These and other features, aspects, and advantages of the present invention will become more apparent from the following description, appended claims, and accompanying exemplary embodiments shown in the drawings.

### BRIEF DESCRIPTION OF THE DRAWINGS

The accompanying drawings, which are incorporated in and constitute a part of the specification, illustrate embodiments of the invention and together with the description, serve to explain the principles of the invention.

FIG. 1 is a perspective view of a cart according to one embodiment of the invention herein described;

FIG. 2 is a perspective view of a cart according to another embodiment of the invention; and

FIG. 3 is a side view of a wheel for use on the cart of the present invention.

### DETAILED DESCRIPTION OF THE PREFERRED EMBODIMENTS

Reference will now be made in detail to the present preferred embodiments of the invention, examples of which are illustrated in the drawings. Wherever possible, the same reference numbers will be used throughout the drawings to refer to the same or like parts.

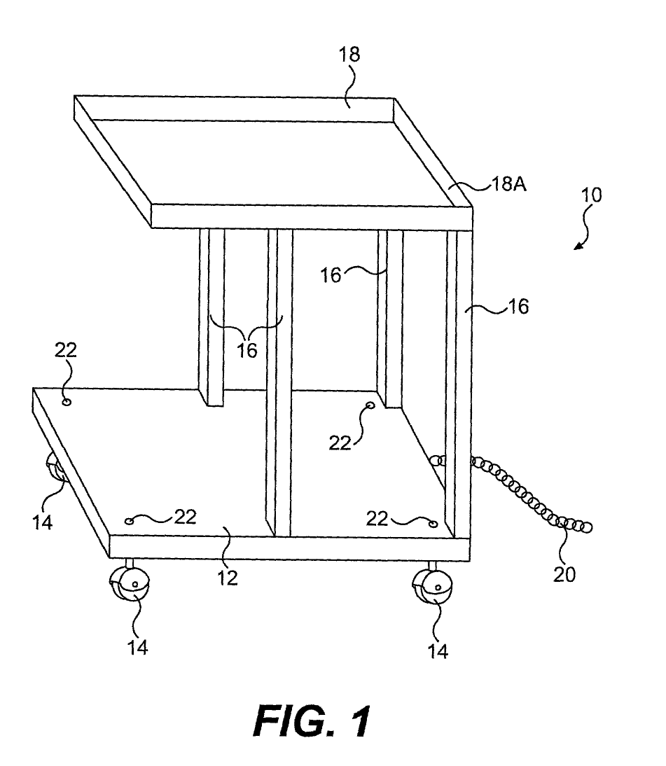

An aspect of the present invention relates to an electrostatic dissipative cart having a cart body 10 and at least one rolling member 14 supporting the cart body 10. FIG. 1 shows a perspective view of a first preferred embodiment of such a cart. The cart body 10 preferably has a base 12, supports 16, and a carrier 18.

The supports 16 are provided to support the carrier 18 above the base 12. Although the preferred four supports 16 are shown in FIG. 1, it is possible to use more or less supports 16. The supports are preferably posts, as shown in FIG. 1. They can, however, assume other configurations, such as a wall or a supporting web.

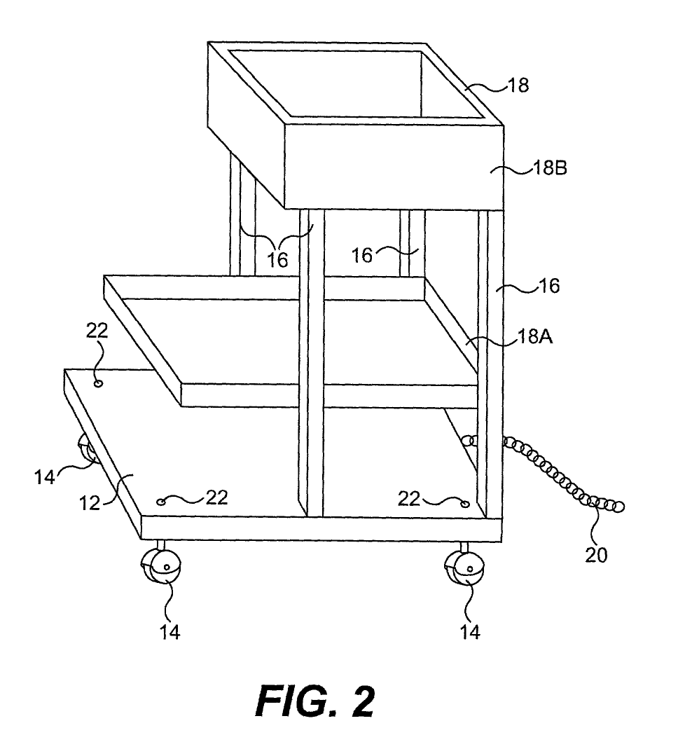

The carrier 18 is provided to carry electronic components. Although only one carrier 18 is shown in FIG. 1, the cart may have multiple carriers, such as the carriers 18A and 1 8B of the second embodiment shown in FIG. 2. The carrier 18 may have a variety of shapes such as being a shelf 18A (as shown in FIGS. 1 and 2) or a bin 18B (as shown in FIG. 2). In addition, the cart body 10 may have a plurality of carriers 18 which may be one or more shelves 18A combined with one or more bins 18B. The cart body 10 may also include other items often associated with maintenance carts such as compartments for storage or supports for holding a refuse container or cleaning devices (e.g. broom, dust pan), etc.

To protect electronic components, preferably at least portion(s) of the cart body 10 are configured such that they will not have a significant stored electrostatic charge and they will not rapidly discharge an electrostatic charge stored in a person or object. More preferably, the cart body 10 will be configured such that all portion(s) of the cart body 10 likely to be contacted by an electronic component will dissipate an electrostatic charge. Even more preferably, all exterior points on the cart body will be configured to dissipate an electrostatic charge. The cart body 10 can be configured such that the portion(s) that dissipate an electrostatic charge will have a resistivity in the range of 10⁶ ohms/square and 10⁹ ohms/square, measured between that portion of the cart body 10 and ground.

Dissipation of electrostatic charge can be achieved by using electrostatic dissipative material to form the cart body 10. An electrostatic dissipative material can be created by adding certain conductive components to a material which would otherwise qualify as an insulator (i.e., a material with a resistivity about 10¹¹ ohms/square). The conductive components provide a conductive matrix to the insulator. Conductive components which may be added include carbon black, nylon, and glass fiber. As a result, there is a blending effect by which the resistivity of the insulator is lowered by the conductivity of the conductive components, but it is not lowered to the resistivity which would be displayed by the conductive components existing outside of the insulator. By adding an appropriate amount of conductive components to an insulator, an electrostatic dissipative material may be created which has a resistivity within a range of 10⁶ to 10⁹ ohms/square, i.e., a resistivity range in which electrical components are much less likely to be damaged by static discharge.

The preferred electrostatic dissipative material used in the cart body 10 is an alloy produced by Carmel Olefins Ltd., P.O. Box 1468, Haifa 31014 ISRAEL and available, under product no. R-170400, from Rubbermaid Commercial Products LLC, 3124 Valley Avenue, Winchester, Va. 22601. The alloy is described in U.S. Pat. No. 5,958,303 which issued to Carmel Olefins and which is incorporated herein in its entirety by reference. Although the precise chemical composition of the Carmel Olefins' alloy is unknown, it is believed to contain nylon, polypropylene, wollastonite, glass fiber, and conductive carbon black. The Carmel Olefins alloy is molded through a conventional structural foam process to create a electrostatic dissipative plastic which is useful in creating various parts of the previously described cart body 10. As the foaming action of the structural foam process creates a random distribution of the various conductive elements in the alloy, the structural foam process aids in optimizing the formation of the conductive matrix. The electrostatic dissipative alloy is molded to form the base 12, the uprights 16, and the at least one carrier 18. The molded plastic will not rust, chip, or peel and is highly resistant to denting.

In a preferred embodiment, substantially all (i.e., greater than 90% and more preferably greater than 95%) of the exterior points on the cart body 10 exhibit the desired resistivity. The focus is on exterior points of the cart body 10, because the interior points will not contact an electrical component. In a more preferred embodiment, all of the exterior points on the cart body 10 exhibit the desired resistivity.

In an alternative preferred embodiment, all of the exterior points on the cart body 10, within a defined region where contact with electronic components is expected, will exhibit the desired resistivity. For example, all exterior points on the cart body 10 four inches or more above the base will exhibit the desired resisitivity. An embodiment of this type would be appropriate if electronic components are not expected to contact exterior points below a selected height, e.g., four inches, and thus the portions of the cart body 10 below that height could be entirely conductive. Above the selected height, however, all exterior points on the cart body 10 exhibit a resistivity in the desired range, i.e., between 10⁶ to 10⁹ ohms/square. The level of the selected height may depend on a number of factors, including: (a) the amount of conductive material added to the plastic forming the cart body (i.e., to create an electrostatic dissipative material); and (b) the conductivity/resistivity of the uprights 16 below the predetermined height.

Desired electrostatic dissipation can be achieved by forming the entire cart body 10 of one or more electrostatic dissipative materials, forming entire components (e.g., base, uprights, carrier) of the cart body 10 of one or more electrostatic dissipative materials, or forming the selected portion(s) of one or more electrostatic dissipative materials. Alternatively, the body 10, components, or portion(s) can be formed of a combination of dissipative and non-dissipative materials that yields the desired electrostatic dissipation. Preferably, the base 12, rolling members 14, uprights 16, and carrier 18 are made of an electrostatic dissipative structural foam plastic.

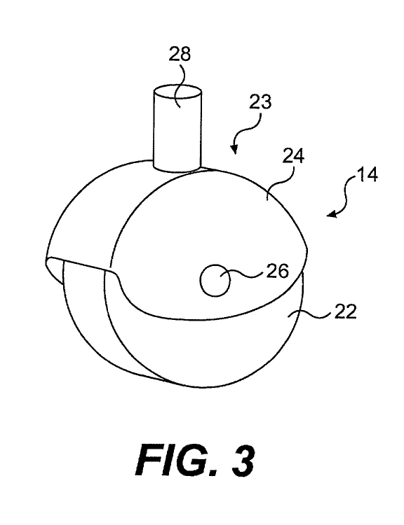

The rolling members 14 attached to the cart body 10 provide the ability for the cart to be readily mobile. Preferably, the base 12 will receive four rolling members 14, at least two of which are swivel casters; the swivel casters facilitating a user's ability to navigate the cart body 10. A preferred rolling member 14 is shown in FIG. 3, and comprises a rolling body 22 and a support structure 23.

Although the rolling body 22 is preferably a wheel, it could, however, take other forms, such as a sphere. In addition, the rolling body 22 preferably has a circular cross sectional shape.

The support structure 24 preferably includes a yoke 24, an axle 26, and a post 28. The axle 26 preferably extends into and through the rolling body 22. The rolling body 22 rotates around the axle 26. The two ends of the axle 26 are connected to the yolk 24. The yolk 24 extends around the two sides of the rolling body 22 and terminates in the post 28 which is adapted to be connected to a transport device such as the previously described cart body 10.

The rolling members 14 may be connected to the base 12 in any of a variety of conventional means. The hardware (not shown) by which the yolk 24 of the rolling member 14 is connected to the base 12 may be conventional items, such as screws or bolts. The rolling member 14 may be connected in a way that prevents it from spinning on a vertical axis of rotation (e.g., a rigid caster). By way of contrast, the rolling member 14 may also be mounted in a conventional fashion by which the rolling member 14 will be able to rotate on a vertical axis of rotation (e.g., a swivel caster).

The hardware for connecting to the base 12 to a rolling members 14 is typically conductive by nature. Moreover, the yolks 24 by which the rolling bodies 22 are attached to the base 12 may also be conductive. However, each rolling body 22 of a particular rolling member 14 preferably contains an electrostatic dissipative material such as that previously described. A rolling member 14 having a rolling body 22 which contains electrostatic dissipative material is manufactured by Faultless Caster 1421 North Garvin Street Evansville, Ind. 47711. Further, although not currently used by the invention, it is conceivable that a rolling member 14 could be designed which would entail a rolling body 22 and the yolk 24 both of which comprise at least one electrostatic dissipative material; such a design may prove more preferable than the current rolling member 14 produced by Faultless Caster.

Although the rolling members 14 may be rigid casters, it is preferred that at least two of the rolling members 14 be swivel casters. Moreover, as previously discussed, it is preferred that the rolling members 14 comprise at least electrostatic dissipative rolling bodies 22. Rigid and swivel casters having electrostatic dissipative rolling bodies 22, as manufactured by Faultless Caster, are available from Rubbermaid Commercial Products under product nos. 21-4500-45 and 20-4500-45, respectively.

In both FIGS. 1 and 2, there is shown a ground chain 20 which may be connected to the cart body 10. The ground chains 20, although largely unnecessary, are designed and intended to provide additional electrical grounding capabilities to the cart body 10 to thereby enhance the cart body's 10 ability to prevent damage to electronic components placed on the cart body carriers 18. As the ground chains 20 are designed to contact the ground, they may be formed from conductive materials, such as metals, to enhance a cart body's 10 ability to prevent a charge from being stored in the cart body 10. The cart bodies 10 in FIGS. 1 and 2 may have additional items thereon which may or may not have electrostatic dissipative properties provided, however, that the cart bodies 10, as a whole, have resistivities which are permanent, consistent, controlled, and are between 10⁶ and 10⁹ ohms/square.

The invention also contemplates a method of transporting electronic equipment sensitive to static electricity. The method includes providing a cart body 10 having the aforementioned electrostatic dissipative properties generated by the Carmel Olefins alloy being molded in a structural foam plastic forming process. Attaching least two rolling members 14 to an underside of the cart body 10. The sensitive electronic components which need to be transported are placed onto a carrier 18 on a cart body 10. The cart body 10 is then moved in a desired direction thereby enabling the user to transport the sensitive electronic components in a manner which ensures the components will not be damaged by static electricity stored in the cart 10.

It will be apparent to those skilled in the art that various modifications and variations can be made to the disclosed preferred embodiments of the present invention without departing from the scope or spirit of the invention. Accordingly, it should be understood that the apparatus and method described herein are illustrative only and are not limiting upon the scope of the invention, which is indicated by the following claims.

What is claimed is:

1. An electrostatic dissipative cart comprising:
a cart body that is grounded and has a resistivity in the range of 10⁶ ohms/square and 10⁹ ohms/square as measured between ground and substantially all exterior points on the cart body; and
at least one rolling member supporting the cart body.

2. An electrostatic dissipative cart according to claim 1, wherein the cart body includes at least one electrostatic dissipative material.

3. An electrostatic dissipative cart according to claim 2, wherein the cart body is formed substantially entirely of electrostatic dissipative material.

4. An electrostatic dissipative cart according to claim 2, wherein the material includes structural foam plastic.

5. An electrostatic dissipative cart according to claim 4, wherein the structural foam plastic includes polypropylene and nylon.

6. An electrostatic dissipative cart according to claim 1, wherein the cart body includes a carrier for carrying electronic components.

7. An electrostatic dissipative cart according to claim 6, wherein cart body further includes at least one support for supporting the carrier.

8. An electrostatic dissipative cart according to claim 7, wherein the cart body further includes a base connected to the at least one support.

9. An electrostatic dissipative cart according to claim 1, wherein the at least one rolling member is grounded and h as a resistivity in the range of 10⁶ ohms/square and 10⁶ ohms/square as measured between substantially all exterior points on the rolling member and ground.

10. An electrostatic dissipative cart according to claim 1, wherein the resistivity of the cart body is in the range of 10⁶ ohms/square and 10⁹ ohms/square as measured between ground and all exterior points on the cart body.

11. An electrostatic dissipative cart body comprising:
a carrier configured to carry at least one electronic component; and
at least one support supporting the carrier,
wherein the carrier and the at least one support each comprise an electrostatic dissipative material.

12. An electrostatic dissipative cart body according to claim 11, wherein the cart body is grounded and has a resistivity in the range of 10⁶ ohms/square and 10⁹ ohms/square as measured between ground and a point selected from the group consisting of all exterior points of the carrier and all exterior points of the at least one support.

13. An electrostatic dissipative cart body according to claim 11, wherein the electrostatic dissipative material is structural foam plastic.

14. An electrostatic dissipative cart body according to claim 13, wherein the structural foam plastic includes an alloy comprising polypropylene and nylon.

15. An electrostatic dissipative cart body comprising:
a carrier configured to carry at least one electronic component; and
at least one support supporting the carrier,
wherein at any selected point on the cart body above a predetermined height, the cart body has a resistivity in the range of 10⁶ ohms/square and 10⁹ ohms/square as measured between ground and the selected point.

16. An electrostatic dissipative cart body according to claim 15, wherein the carrier and the at least one support each comprise an electrostatic dissipative material.

17. An electrostatic dissipative cart body according to claim 16, wherein above the predetermined height the at least one support and the carrier comprise structural foam plastic.

18. A rolling member comprising:
a rolling body having a substantially circular cross section and comprising at least one electrostatic dissipative material; and
a support structure connected to the rolling body and adapted to be connected to a platform.

19. A rolling member according to claim 18, wherein the rolling body is grounded and has a resistivity in the range of 10⁶ ohms/square and 10⁹ ohms/square as measured between ground and any point on the rolling body.

20. A wheel according to claim 18, wherein the support structure includes a yolk and an axle extending into the rolling body.

21. A method for transporting electronic components comprising the steps of:
providing a cart body having at least one support upright, at least one carrier supported by the at least one support upright, and at least two rolling members attached to an underside of the cart body;
placing at least one electronic component on the at least one carrier;
moving the cart by rolling the cart via the at least two rolling members,
wherein the at least one support upright and the at least one carrier comprise at least one electrostatic dissipative material.

22. The method according to claim 21, wherein the at least one carrier is a shelf or a bin.

23. The method according to claim 21, wherein the electrostatic dissipative material has a resistance between 10⁶ ohms/square and 10⁹ ohms/square.

24. The method according to claim 21, wherein the electrostatic dissipative material is structural foam plastic.

25. The method according to claim 24, wherein the structural foam plastic includes an alloy comprising polypropylene and nylon.

26. A method for transporting electronic components comprising the steps of:
providing a cart body having at least one support upright, at least one platform supported by the at least one support upright, and at least two rolling members attached to an underside of the cart body;
placing at least one electronic component on the at least one platform;
moving the cart by rolling the cart via the at least two rolling members,
wherein the cart body is grounded and has a resistivity in the range of 10⁶ ohms/square and 10⁹ ohms/square as measured between ground and substantially all exterior points on the cart body.

27. The method according to claim 26, wherein each of the rolling members comprises a rolling body and a support structure, and wherein the resistivity of the rolling body, as measured between any point on the rolling body and the ground, is between 10⁶ ohms/square and 10⁹ ohms/square.

28. A method of forming a structure comprising the steps of:
providing an electrostatic dissipative material; and
forming the material into structural foam plastic.

29. A product comprising:
structural foam plastic, wherein the structural foam plastic includes electrostatic dissipative material.

30. The material according to claim 29, wherein when the structural foam plastic is electrically connected to ground, the structural foam plastic exhibits a resistivity, as measured between a position on the structural foam plastic and the ground, between 10⁶ ohms/square and 10⁹ ohms/square.
